(19) United States
(12) Patent Application Publication
(10) Pub. No.: US 2024/0416590 A1
(43) Pub. Date: Dec. 19, 2024

(54) Composite Manufacturing Method based on Powder Bed and Five-Axis Additive and Subtractive Materials

(71) Applicant: Xi’an Jiaotong University, Xi’an City, Shaanxi Province (CN)

(72) Inventors: Qi ZHANG, Xi’an (CN); Yin WANG, Xi’an (CN); Yukai CHEN, Xi’an (CN); Yu LU, Xi’an (CN); Junyao WANG, Xi’an (CN); Bin HAN, Xi’an (CN)

(21) Appl. No.: 18/705,576

(22) PCT Filed: Aug. 7, 2023
(86) PCT No.: PCT/CN2023/111460

§ 371 Date: Apr. 28, 2024

(30) Foreign Application Priority Data
Sep. 15, 2022 (CN) 2022 11119934.8

(51) Int. Cl. B29C 64/393; B33Y 50/02; G06F 30/20; G06F 113/10

(52) U.S. Cl. CPC B29C 64/393; G06F 30/20; B33Y 50/02; G06F 2113/10

(57) ABSTRACT

A composite manufacturing method based on powder bed and five-axis additive and subtractive materials includes model Preprocessing: processing model adaptive compensation based on a design model and repairing the model after model compensation to obtain an additive model; decomposition and reconstruction: decomposing the additive model to obtain multiple sub-models that can plan the internal surface tool path at one time, and then processing additive manufacturing and CNC machining alternately for the sub-models according to the build sequence until composite manufacturing of all sub-models is completed; and post-processing: removing support structure and milling outer surface of the part after composite manufacturing of all sub-models is completed, in addition, after the influence of the powder bed and support is removed, reprocessing a non-machined part of internal structure to obtain a final required part. The present invention can realize the manufacturing of parts with complex internal structures that are difficult to process by traditional CNC machining and provides technical support for the integrated precision manufacturing of complex internal structure parts.

### BACKGROUND OF THE PRESENT INVENTION

### Field of Invention

The present invention relates to the technology field of composite manufacturing with additive and subtractive material, in particularly to a composite manufacturing method based on powder bed and five-axis additive and subtractive materials.

### Description of Related Arts

Additive-subtractive composite manufacturing technology combines the advantages of high design freedom of additive manufacturing and high surface accuracy of CNC machining, eliminates the “step effect” caused by the discrete accumulation principle of additive manufacturing, and improves the surface accuracy of additive manufacturing parts, expands the manufacturing range of CNC machining, and provides solutions for integrated precision manufacturing of parts (for example: parts with complex internal structures) that are difficult to manufacture with CNC machining.

There are two main additive methods for metal additive-subtractive composite manufacturing: direct energy deposition (DED) and powder bed fusion (PBF). Wherein composite manufacturing equipment using DED as an additive method can be realized by integrating a cladding head on a five-axis CNC machine tool. The manufacturing and control of the equipment are easy to implement, and it is suitable for rapid manufacturing of large parts and parts repairing. Compared with the DED process, the composite manufacturing method based on the PBF process has higher surface accuracy, can form fine structures, and is more suitable for integrated precision manufacturing of complex internal structures (for examples: parts with internal flow channels). It has broad application prospects in aerospace, automotive, biomedical and other fields.

Existing additive-subtractive material manufacturing methods ([1] V. T. Le, H. Paris, G. Mandil, The development of a strategy for direct part reuse using additive and subtractive manufacturing technologies, Addit. Manuf. 22 (2018) 687-699; [2] S. T. Newman, Z. C. Zhu, V. Dhokia, A. Shokrani, Process planning for additive and subtractive manufacturing technologies, CIRP Ann.—Manuf. Technol. 64 (2015) 467-470) are mostly oriented to the parts repairing, and only use the characteristics of the model itself to plan the operation sequence between additive manufacturing and CNC machining in the manufacturing stage. On the other hand, additive-subtractive material manufacturing based on PBF is restrictive due to the influence of the powder bed, its construction direction is single, and the swing head cannot be processed lower than the surface of the powder bed during the composite manufacturing process. Therefore, the current additive-subtractive material composite manufacturing method is only suitable for DED additive-subtractive material composite manufacturing with a high degree of freedom and is not suitable for PBF additive-subtractive material composite manufacturing that is suitable for integrated precision manufacturing of complex internal structures.

In addition, powder bed additive manufacturing technology is limited by the maximum construction angle (the angle between the tangent of the model surface and the construction direction (Z direction)). When printing a large-angle overhang structure, it is necessary to add a support structure to this part of the structure to resist thermal deformation and scraper force. When printing is completed, the support structure needs to be removed. However, some supports for internal structures are often difficult to remove, and when the supports are removed, the internal stress of the part will be released, resulting in deformation of the part and affecting the overall accuracy of the part.

Existing powder bed support-free printing technologies are mostly implemented using non-contact scrapers or real-time optimization of process parameters. For example, in CN108436082A, although it can reduce the number of supports for parts, it still needs to add supports for overhang structures with an angle close to 90°, which will still make it difficult to remove the internal supports. Moreover, the forming quality of the lower surface of the large-angle overhang structure is poor and there are many internal defects.

### SUMMARY OF THE PRESENT INVENTION

In order to solve the above problems in the existing technology, the present invention provides an additive and subtractive composite manufacturing method based on powder bed and five-axis, which fully considers the impact of PBF process characteristics and constraints on the CNC machining process; and through reasonable model self-support design and tool selection, achieves powder bed support-free printing of large-angle overhanging internal cavity structures, therefore capable of realizing integrated precision manufacturing of complex internal structure parts, which is beneficial to the surface quality improvement and shape control of parts in additive and subtractive composite manufacturing.

In order to achieve the above objective, the present invention adopts the following technical solutions:
a composite manufacturing method based on powder bed and five-axis additive and subtractive materials, which comprises the steps of:
(a) Model Preprocessing: processing model adaptive compensation based on a design model, determining whether the model after compensation has STL errors, repairing the model if the model is determined to have errors until a complete, error-free, watertight STL model is formed, then defining the model as an additive model for the entire additive and subtractive composite manufacturing, and carrying out subsequent processing;
(b) Decomposition and reconstruction: decomposing the additive model to obtain multiple sub-models that can plan the internal surface tool path at one time, and then process model reconstruction for the sub-models alternately in order of construction sequence until composite manufacturing of all sub-models is completed;
(c) Post-processing: removing support structure and milling outer surface after composite manufacturing of all sub-models is completed; in addition, reprocessing a part of raw internal structure after influence of the powder bed and support is removed to obtain a final required part.

In step (a), rules of model adaptive compensation are expanding an outer contour and shrinking an internal contour of the model to achieve an effect of leaving a suitable finishing allowance, and the step is realized by developing a model adaptive compensation algorithm; in addition, if the model comprises a large-angle overhanging structure, a corresponding structure for self-supporting needs to be designed.

The free-of-support strategy is: when building a sub-model having a large-angle overhanging internal cavity structure, set a first layer cutting area to a lower 9/10 part of a first layer self-supporting structure and keep an upper 1/10 part; set an n-th (n>1) layer cutting area to a lower 9/10 part of an n-th layer self-supporting structure and an upper 1/10 part of an n−1 layer; set a last layer of cutting area as a last layer of the self-supporting structure part and 1/10 part of a penultimate layer; generate subtractive processing tool paths for each layer according to selected processing tool parameters and setting of cutting area for subtractive processing.

The processing tool uses a T-shaped milling cutter to process the negative-angle self-supporting structure; according to the different forms of processing surfaces, T-type milling cutters with different specifications and parameters are selected.

The model reconstruction stage is based on the processing accuracy requirements. The sub-models obtained during the model decomposition phase and the processing tool path files obtained during the internal surface tool path planning stage are used to process additive manufacturing and CNC machining alternately according to the build sequence until composite manufacturing of all sub-models is completed.

The reprocessing of step (c) refers to: during the composite manufacturing process of the additive model during the decomposition and reconstruction stage, due to CNC machining being limited by the process characteristics of PBF, part of the internal surface of the part cannot be finished; after removing the influence of powder and support, the five-axis machine tool is used to finish the unmachined internal surface of the part again.

The composite manufacturing method based on powder bed and five-axis additive and subtractive materials utilizes a machine which comprises: an atmosphere protection shell 1, a five-axis rotary head 2 arranged inside the atmosphere protection shell 1, a cutting tool 9 connected to a bottom portion of the five-axis rotary head 2, a linear motor 10 connected to the five-axis rotary head 2, a laser galvanometer 3 connected to the linear motor 10, a powder spreading scraper 4 provided at a bottom portion of the atmosphere protection shell 1, a forming base plate 7 is provided at a lower middle part of the atmosphere protection shell 1 in which a powder bin 5 and a top powder mechanism 6 are provided at one side and a powder collecting bin 8 is provided at another side, the atmosphere protection shell 1 serves to form a low-oxygen environment to prevent the powder from over-burning.

The advantageous effect of the present invention is:

(1) The present invention comprehensively considers the impact of PBF process characteristics and constraints on the CNC machining process, and divides the powder bed and five-axis additive and subtractive composite manufacturing methods into three steps: model preprocessing, decomposition and reconstruction, and post-processing, which is conducive to the realization of complex internal processes. Integrated precision structural parts.

(2) According to the present invention, the model adaptive compensation algorithm being adopted has the advantages of universality, accuracy and speed, can reduce the tedious and error-prone manual compensation of complex structural parts, and is beneficial to the improvement of surface quality and shape control of parts in composite manufacturing of additive and subtractive materials.

(3) According to the present invention, self-supporting optimized design is adopted to replace the support structure of the original large-angle overhang structure during additive manufacturing, which can improve the printing quality of the large-angle overhang structure.

(4) According to the present invention, the support function of the lower structure to subsequent layers is realized through customized free-of-support strategies and T-shaped cutters. Compared with the shortcomings of traditional methods such as the difficulty in removing the internal support structure and poor surface forming quality, the present invention can remove the internal self-supporting structure step by step during the composite manufacturing process of additive and subtractive materials, therefore achieving integrated precision manufacturing of structural parts with large overhanging internal cavities.

(5) According to the present invention, a reprocessing process in the post-processing step is adopted, which can allow some unprocessed areas in the decomposition and reconstruction stage to be processed again after removing the influence of the powder bed and support, which is conducive to the improving the overall surface quality of the parts.

### BRIEF DESCRIPTION OF THE DRAWINGS

FIG. 1 illustrates a flowchart according to the present invention.

FIG. 2 is a schematic diagram of rules of model adaptive compensation according to the present invention.

FIG. 3 is a schematic diagram of the basic idea of the model adaptive compensation algorithm according to the present invention; wherein FIG. (a) shows the distribution of triangular patches around a certain vertex on the same plane; FIG. (b) shows the distribution of triangular patches around a certain vertex on two planes; FIG. (c) shows the distribution of triangular patches around a certain vertex on three or more planes.

FIG. 4 is an exemplary illustration of the self-supporting design according to the present invention; wherein (a) illustrates the design model and (b) illustrates the optimization model.

FIG. 5 is a schematic diagram of the machine being used according to the present invention

FIG. 6 a schematic diagram showing the alternative processing between additive manufacturing and CNC machining according to the present invention.

FIG. 7 is a schematic diagram of the influence of different model placement angles on the internal processable area according to the present invention; wherein FIG. (a) is a horizontal placement, and FIG. (b) is an inclined placement.

FIG. 8 a schematic diagram of the additive and subtractive composite manufacturing process of a complex internal cavity part according to a preferred embodiment of the present invention.

FIG. 9 a schematic diagram of the supported-free composite manufacturing process of the large-angle overhang internal cavity structure with additive and subtractive materials according to a preferred embodiment of the present invention.

### DETAILED DESCRIPTION OF THE PREFERRED EMBODIMENT

The present invention is further described in details below with reference to specific preferred embodiments and accompanying drawings.

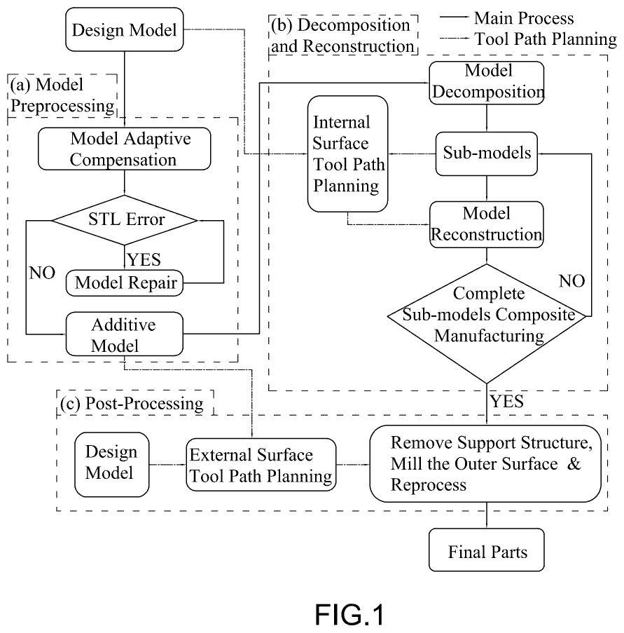

Referring to FIG. 1 of the drawings, a method, comprising the steps of:

(a) Model Preprocessing: Because the surface accuracy of additive-subtractive composite manufacturing parts is guaranteed by CNC, taking into account the finishing allowance, model adaptive compensation needs to be performed on the basis of a design model to obtain an additive model; in addition, in order to prevent the compensated additive model from producing STL errors (such as crossed triangle patches, etc.), the compensated model needs to be repaired until a complete, error-free, watertight STL model is formed, which can then be used as an additive model for the entire additive-subtractive composite manufacturing for subsequent processing.

(b) Decomposition and reconstruction: After comprehensively considering the impact of PBF process characteristics and constraints on the CNC machining process and model characteristics, decompose the additive model obtained in step (a) to obtain multiple sub-models that can plan the internal surface tool path at one time, and then reconstruct the sub-models alternately in order of construction until composite manufacturing of all sub-models are completed.

(c) Post-processing: After the composite manufacturing of all sub-models is completed, the support structure needs to be removed and the outer surface is milled. In addition, after removing the influence of the powder bed and supports, part of the raw internal structure is reprocessed to obtain the final required part.

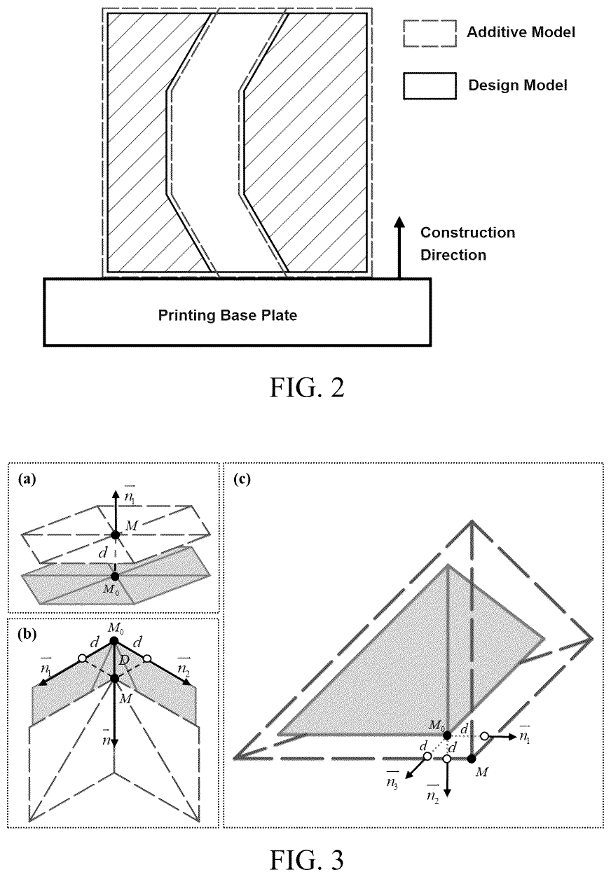

Referring to FIG. 2 of the drawings, rules of the model adaptive compensation comprises expanding an outer contour and shrinking an internal contour of the model to achieve the effect of leaving a suitable finishing allowance. Model compensation can be realized manually through CAD software, but when faced with parts with more complex structures, manual compensation is often cumbersome and prone to errors. In addition, manual compensation cannot combine the process characteristics of PBF to make adaptive adjustments to different areas; therefore, developing a model adaptive compensation algorithm will improve the finishing allowance in terms of time, effect, adaptability, etc.

The meaning of adaptive refers to: under the condition of having determined machine, materials and processes, the model deviation for different model characteristics which is caused by the additive process is compensated. This is because considering that the finishing allowance is generally small, while during the printing process, due to machine, materials, processes and the characteristics of the model (mainly the inclination angle of the triangular surface) will also cause the size of the actual model to be inconsistent with the designed model. If this deviation exceeds the value of the finishing allowance, it will be detrimental to the progress of CNC machining. Therefore, in addition to leaving a finishing allowance, model compensation also needs to compensate for the model deviation caused by the additive process. Adaptive rules are explored by printing models at different tilt angles and measuring lengths and angles deviations between an actual size and a design size.

Referring to FIG. 3 of the drawings, the basic idea of the model adaptive compensation algorithm is: in order to leave a finishing allowance, move the plane where each triangular patch in the original model is located along the normal vector direction, that is, to the outer side of the model, which is the sum of the finishing allowance and the model deviation during the additive process; obtain the new three vertex coordinates of each triangular patch by calculating the intersection points of each plane after translation, and recalculate the normal vector; output the three vertices and normal vectors of each transformed triangle patch into STL format according to the rules to obtain the compensated model.

The mathematical principle of the model adaptive compensation algorithm to solve the new vertices after slice translation of each triangular patch is:

without loss of generality, assume that the coordinates of a certain vertex before change are M₀=(x₀, y₀, z₀), and the coordinates after transformation are M, the triangular patches around point M₀ are distributed on n-th independent planes, and their independent plane normal vectors are: \vec{n_{ι}}=(Aᵢ, Bᵢ, Cᵢ), i=1 . . . n, when the adaptive rules are not considered, the translation distance of each triangular patch along the direction of the normal vector is d.

Referring to FIG. 3(a) of the drawings, when the triangular patches around a vertex are distributed on the same plane, that is, when n=1, the vertex transformation rule can be regarded as a translation distance d along the direction of the normal vector of the plane, that is, the coordinate transformation formula of the vertex is:

$$M = {M}_{0} + \vec{{n}_{1}} \cdot d$$

Referring to FIG. 3(b) of the drawings, when the triangular patches around a vertex are distributed on two planes, that is, when n=2, the vertex transformation rule can be regarded as a translation distance D along the combined vector direction of the two planes, that is, the coordinate transformation formula of the vertex is:

$$M = {M}_{0} + \vec{n} \cdot D = {M}_{0} + \vec{n} \cdot \frac{d}{cos 〈 \vec{n} , \vec{{n}_{1}} 〉}$$

Referring to FIG. 3(c) of the drawings, when the triangular patches around a vertex are distributed in three or more planes, that is, when n≥3, solving the changed vertex coordinates at this time can be transformed into a problem of finding intersection points on multiple planes, that is, the coordinate transformation formula of the vertex is:

arg min∥Am−b∥

where A is the plane equation coefficient matrix, m is the transformed point coordinates, and b is a constant term, and their expressions are as follows:

$$A = ( \begin{matrix}{A}_{1} & {B}_{1} & {C}_{1} \\ ⋮ & ⋱ & ⋮ \\ {A}_{n} & {B}_{n} & {C}_{n}\end{matrix} )$$

$$m = {( x , y , z )}^{T}$$

$$b = ( \begin{matrix}{A}_{1} ( {x}_{0} + {dA}_{1} ) + {B}_{1} ( {y}_{0} + {dB}_{1} ) + {C}_{1} ( {z}_{0} + {dC}_{1} ) \\ ⋮ \\ {A}_{n} ( {x}_{0} + {dA}_{n} ) + {B}_{n} ( {y}_{0} + {dB}_{n} ) + {C}_{n} ( {z}_{0} + {dC}_{n} )\end{matrix} )$$

Model adaptive compensation can be achieved by modifying the normal vector direction \vec{n_{ι}}=(Aᵢ, Bᵢ, Cᵢ), i=1 . . . n and distance d in the above coordinate transformation rules based on the adaptive rules explored through experiments of the translation direction and distance of each patch.

After changing the adaptive rules, the model adaptive compensation can also be used in other forms of additive and subtractive material composite manufacturing to realize the reservation of finishing allowance in the additive and subtractive material composite manufacturing process from the model level.

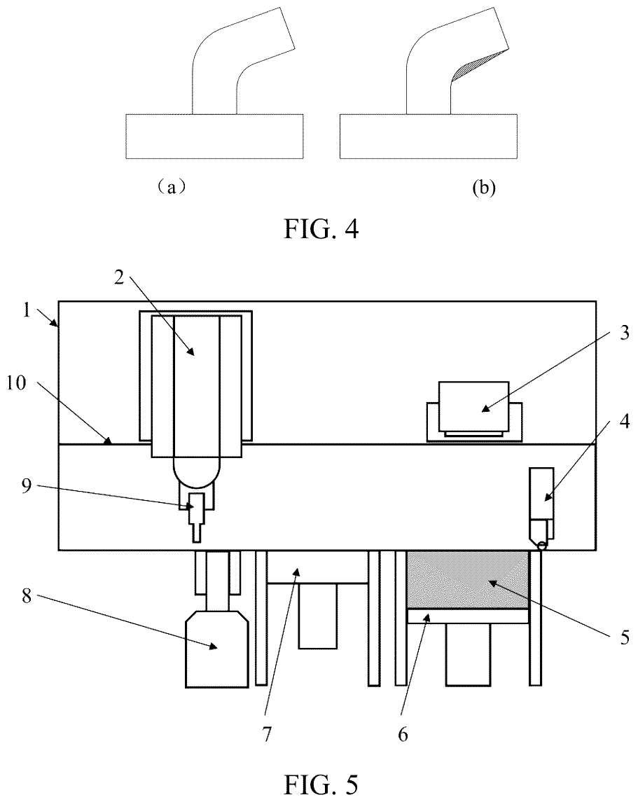

Referring to FIG. 4 of the drawings, the self-supporting design is as follows: First determine the maximum build angle of the powder bed of the additive manufacturing machine; then look for the surface in the design model whose angle between the tangent direction and the construction direction is greater than the maximum construction angle, that is, a large-angle overhang surface; finally, the angle of the large-angle overhanging surface is compensated to the maximum construction angle of the device, so that it can be free-of-support during the printing process and the optimized model can be obtained; the self-supporting structure added in the self-supporting design can be removed in subsequent subtractive processing.

Referring to FIG. 1 of the drawings, the step (b) comprises three stages: model decomposition, internal surface tool path planning and model reconstruction.

The model decomposition stage is: based on the internal structural characteristics of the additive model under the determined placement angle, machining accuracy and tool parameters of the additive model, use multiple cutting planes perpendicular to the construction direction to decompose the additive model into multiple sub-models that can plan the internal surface machining tool path at one time and output the sub-model construction sequence.

The internal surface tool path planning stage is to improve manufacturing efficiency and prevent damage to the support structure. At this time, CNC machining only processes the internal surface of the part. When planning the machining tool path, each sub-model after the additive model is decomposed is used as a blank, and the design model is used as the target component. If the model has a large-angle overhanging internal cavity structure, a free-of-support strategy is needed to achieve support-free integrated manufacturing of the internal large-angle overhanging structure. The internal surface tool path planning stage will generate the same number of processing tool path files as the number of sub-models.

The model reconstruction stage is based on the machining accuracy requirements. The sub-models obtained in the model decomposition stage and the processing tool path files obtained in the internal surface tool path planning stage are alternately processed by additive manufacturing and CNC machining according to the construction sequence until composite manufacturing of all sub-models is completed.

In step (c), reprocessing refers to: in the composite manufacturing process of the additive model in the decomposition and reconstruction stage, due to CNC machining being limited by the process characteristics of PBF (for example, the swing head cannot be processed below the surface of the powder bed, and it interferes with the support structure, etc.), part of the internal surface of the part cannot be finished. After removing the influence of powder and support structure, the five-axis machine tool is used to fine finishing the unmachined internal surface of the part again.

Referring to FIG. 5 of the drawings, a machine used in the additive and subtractive composite manufacturing method based on powder bed and five-axis comprises: an atmosphere protection shell 1, a five-axis rotary head 2, a laser galvanometer 3, a powder spreading scraper 4, a powder bin 5, a top powder mechanism 6, a forming base plate 7, a powder collecting bin 8, a cutting tool 9 and a linear motor 10. The five-axis rotary head 2 inside the atmosphere protection shell 1. The bottom of the five-axis rotary head 2 is connected with the cutting tool 9. The five-axis rotary head 2 is connected to the linear motor 10, and the linear motor 10 is connected to the laser galvanometer 3; the bottom of the atmosphere protection shell 1 is provided with a powder spreading scraper 4.

There is a forming base plate 7 in the lower middle of the atmosphere protection shell 1, a powder bin 5 and a powder top mechanism 6 are arranged on one side, and a powder collecting bin 8 is arranged on the other side.

Wherein the atmosphere protection shell 1 functions to form a low-oxygen environment to prevent the powder from over-burning; the powder collection bin 8 functions to collect excess powder during the powder spreading process.

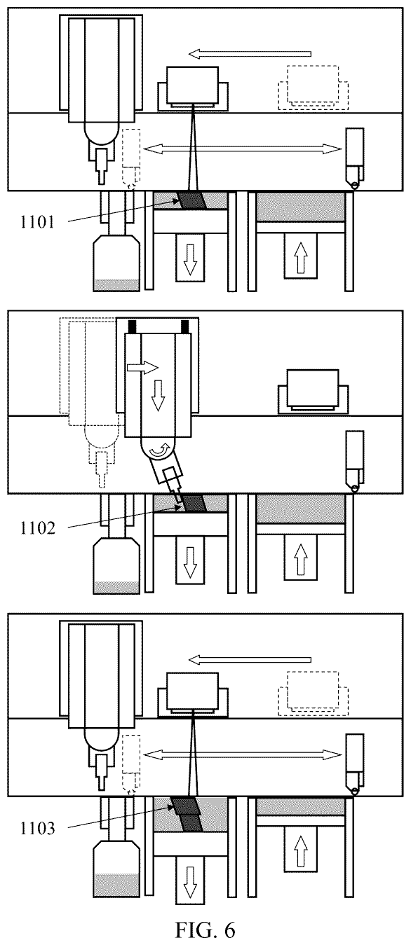

Referring to FIG. 5 and FIG. 6 of the drawings, alternate processing of additive manufacturing and CNC machining refers to: the bottommost sequence sub-model 1101 is first formed through additive manufacturing, and the specific additive manufacturing process is as follows: driven by the linear motor 10, the laser galvanometer 3 moves to the center of the forming base plate 7 and prints layer by layer. At this time, the top powder mechanism 6 pushes the powder bin 5 to move upward, the forming base plate 7 moves downward, and the powder spreading scraper 4 moves back and forth until the entire sub-model 1101 is printed.

After the sub-model 1101 is printed, driven by the linear motor 10, the laser galvanometer 3 exits the center of the forming base plate 7, and the five-axis rotary head 2 moves to a suitable position to perform CNC machining on the sub-model 1101. At this time, the powder spreading scraper 4, the top powder mechanism 6, and the forming base plate 7 all remain stationary. After the sub-model 1101 is processed according to the tool path as planned, the sub-model 1102 after the composite manufacturing of additive and subtractive materials in the bottom sequence can be obtained.

After the bottom sequence sub-model 1102 is completed, the five-axis rotary head 2 will be withdrawn. The laser galvanometer 3 is moved to the center of the forming base plate 7 to continue additive manufacturing on the sub-model 1102, and building the next sequence of sub-models 1103. In this way, additive manufacturing and CNC machining of each sub-model is processed according to the construction sequence until all sub-models are combined and completed.

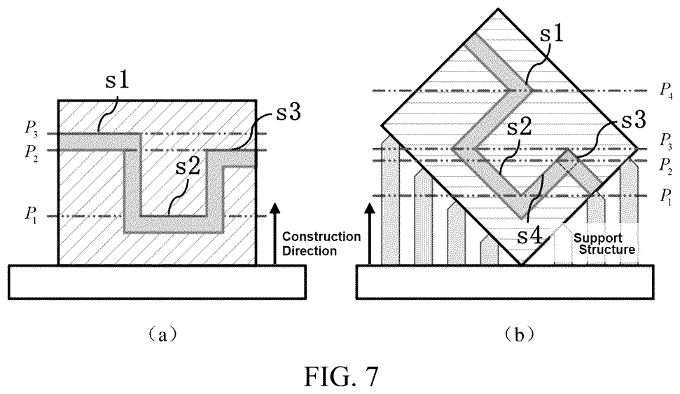

Referring to FIG. 7 of the drawings, the location of the cutting plane should be determined based on the model placement angle and internal structure. Taking an “ [symbol] ”-shaped internal flow channel as an example, if we want to achieve integrated precision manufacturing of this model, we need to use different cutting planes to divide the model into multiple sub-models according to the structural characteristics of the internal flow channel (generally, the internal top surface/edge is selected as the cutting surface). As shown in FIG. 7(a), when the model is placed horizontally, three cutting planes P₁, P₂, and P₃ are selected to divide the model into four sub-models, then each sub-model is sequentially processed by additive and subtractive manufacturing according to a construction sequence. At this time, most of the internal surfaces can be precision finishing, but the internal surfaces s1, s2, and s3 cannot be precision finished in step (b) due to the limitations of the powder bed and the model itself. As shown in FIG. 7(b), when the model is placed inclinedly, four cutting planes P₁, P₂, P₃, P₄ are selected to divide the model into five sub-models. Because the model is tilted, it is necessary to add an external support structure. After all sub-models are processed by additive and subtractive manufacturing, only the partial area of the internal surfaces s3 and s4 between the cutting planes P₂ and P₃ cannot be precision finished.

Referring to FIG. 7 of the drawings, the reprocessing means that after removing the influence of factors such as powder bed and support, part of the internal surface that is not processed in step (b) can be precision finishing again. For example, the internal surfaces s1 and s3 in FIG. 7(a). However, the internal surface s2 cannot be reprocessed due to the limitations of the model characteristics. In FIG. 7(b), the part of area between the cutting planes P₂ and P₃ of the internal surfaces s3 and s4 can be reprocessed after removing the support and powder.

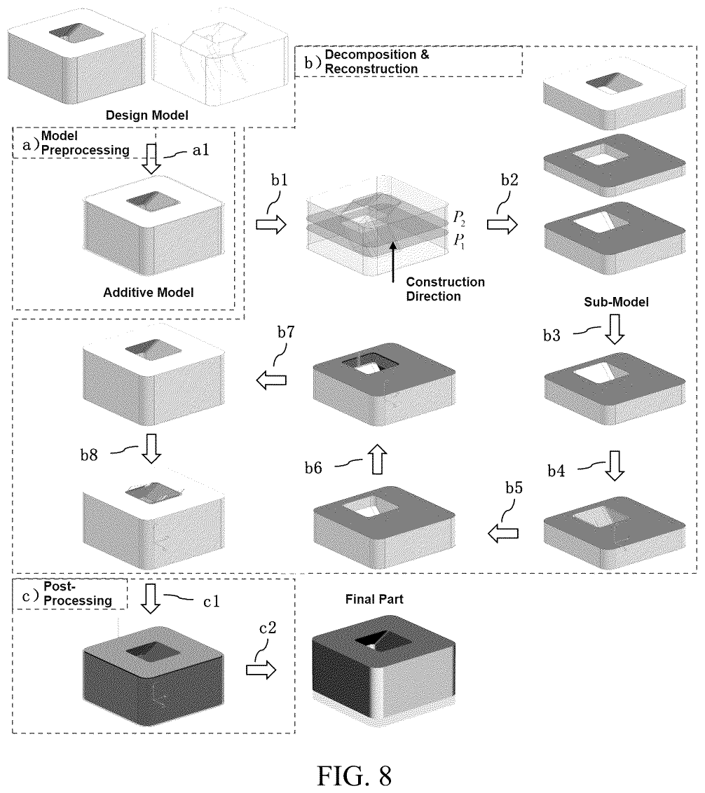

Referring to FIG. 8 of the drawings, a complex internal cavity part is used to illustrate the composite manufacturing method based on powder bed and five-axis additive and subtractive materials of the present invention.

The design model in FIG. 8 has a side V-shaped internal cavity, which can be divided into three sections and has rounded corners. If traditional multi-axis CNC machining is used, the internal surface of the middle section cannot be processed. If additive manufacturing is used, then there is unmelted powder adhering to the surface of the internal cavity and the roughness is large. The integrated precision manufacturing of the internal cavity model can be achieved by adopting the composite manufacturing method based on powder bed and five-axis additive and subtractive materials of the present invention. The specific manufacturing process is as follows:

First, perform model adaptive compensation and STL repair (a1) on the design model to obtain an additive model with appropriate precision finishing allowance. Select a horizontal placement direction and select a cutting plane (b1) according to the internal cavity characteristics (corner) of the additive model. Divide the additive model into three sub-models (b2) according to the selected cutting planes P₁ and P₂. The sub-models are alternately processed by additive manufacturing and CNC machining (b3)˜(b8) in order of construction, wherein steps (b3), (b5) and (b7) are additive manufacturing processes; and (b4), (b6) and (b8) are CNC machining processes, and only the internal surface of the cavity is the CNC machining area. After the three sub-models are compositely manufactured, the model is taken out of the powder bed. The surface machining tool path (c1) is planned and the outer surface of the model (c2) is milled to obtain the final integrated precision-formed internal cavity part.

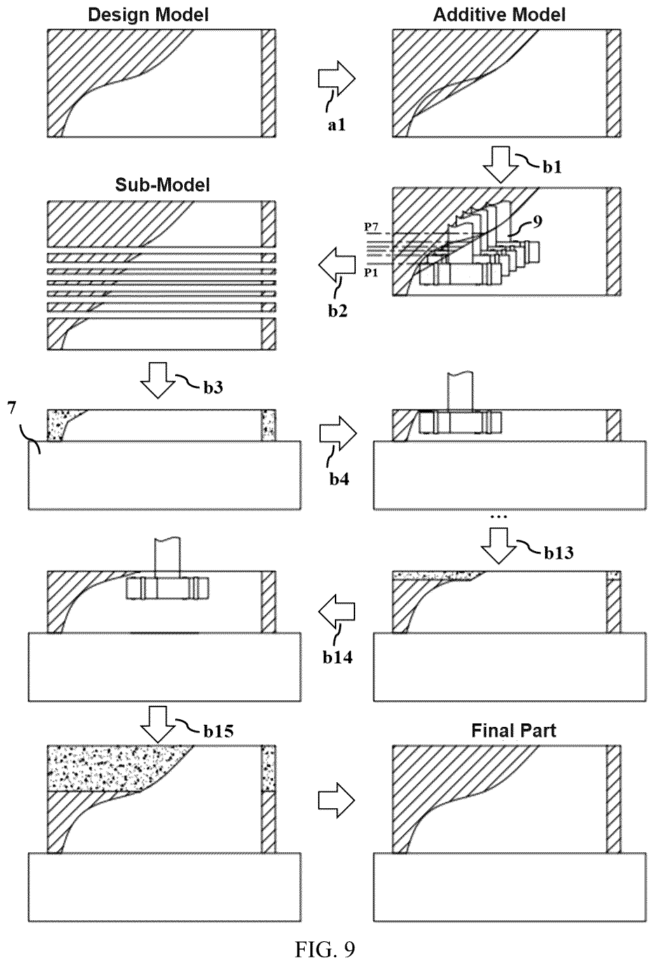

Referring to FIG. 9 of the drawings, a certain cantilever internal cavity structure with a large angle is used to illustrate a free-of-support printing method by using the composite manufacturing method based on a powder bed and five-axis additive and subtractive material of the present invention. The specific manufacturing process is as follows:

First, the design model is converted into an additive model through self-supporting design (a1). Then determine the model decomposition plane (b1) based on the model characteristics and the parameters of cutting tool 9. Divide the additive model into eight sub-models (b2) according to the selected cutting planes P₁-P₇.

The sub-models are alternately processed by additive manufacturing and CNC machining (b3)˜(b15) in order of construction, wherein (b3), (b5), . . . , (b15) are steps of the additive manufacturing process; and (b4), (b6), . . . , (b14) are steps of the CNC machining processes; wherein the cutting area (b4) is the lower 9/10 part of the first layer's self-supporting structure, and reserve the upper 1/10 part; the cutting areas (b6), (b8), . . . , (b12) are the lower 9/10 part of the current layer's self-supporting structure and the upper 1/10 part of the lower layer; the cutting area (b14) is the part of the last layer of the self-supporting structure and the upper 1/10 part of the penultimate layer. By reserving 1/10 of the self-supporting structure on each layer, the additive manufacturing of the upper layer can be smoothly carried out. After all sub-models are processed, the target part is obtained. This method overcomes the problem of difficulty in removing the traditional support structure of the internal cavity, and effectively improves the size and surface accuracy of the large-angle overhang internal cavity in additive manufacturing.

What is claimed is:

1. A composite manufacturing method based on powder bed and five-axis additive and subtractive materials, characterized in that, comprising the following steps:
(a) Model Preprocessing: processing model adaptive compensation based on a design model, determining whether the model after compensation has STL errors, repairing the model if the model is determined to have errors until a complete, error-free, watertight STL model is formed, then defining the model as an additive model for the entire additive and subtractive composite manufacturing, and carrying out subsequent processing;
(b) Decomposition and reconstruction: decomposing the additive model to obtain multiple sub-models that is capable of planning an internal surface tool path at one time, and then reconstructing the sub-models alternately in order of construction until composite manufacturing of all sub-models is completed;
(c) Post-processing: removing support structure and milling outer surface after the composite manufacturing of all sub-models is completed; in addition, reprocessing a non-machined part of internal structure after influence of the powder bed and support is removed to obtain a final required part.

2. A method according to claim 1, characterized in that, in step (a), the model adaptive compensation having rules which expand an outer contour and shrink an internal contour of the model to achieve an effect of leaving a suitable precision finishing allowance, and the step is realized by developing a model adaptive compensation algorithm; in addition, if the model comprises a large-angle overhanging structure, a corresponding structure for self-supporting needs to be designed.

3. A method according to claim 2, characterized in that, wherein the meaning of adaptive refers to compensating a model deviation for different model characteristics which is caused by an additive process under a condition of having determined equipment, materials and processes, that model compensation also needs to compensate for the model deviation caused by the additive process in addition to leaving a precision finishing allowance; adaptive rule refer to processing exploration by printing models at different inclination angles and measuring a length and an angle deviations between an actual size and a design size.

4. A method according to claim 2, characterized in that, wherein a basic idea of the model adaptive compensation algorithm is: in order to leave a precision finishing allowance, a plane where each triangular patch in the original model is located is moved along a normal vector direction, that is a sum of the precision finishing allowance for slice translation in an external side of the model and the model deviation during the additive process; obtain three new vertex coordinates of each of the triangular patch by calculating intersection points of each plane after slice translation, and recalculate a normal vector; output the three new vertices of each of the triangle patch being transformed and the normal vector into a STL format according to the rules to obtain the compensated model.

5. A method according to claim 4, characterized in that, a mathematical principle of the model adaptive compensation algorithm to solve and obtain the new vertices after a slice translation of each triangular patch is:
assume that coordinates of a certain vertex before change is M₀=(x₀, y₀, z₀), and coordinates after transformation are M, the triangular patches around point M₀ are distributed on n-th independent planes, and their independent plane normal vectors are: \vec{n_{ι}}=(Aᵢ, Bᵢ, Cᵢ), i=1 . . . n, when adaptive rules are not considered, the translation distance of each triangular patch along the direction of the normal vector is d;
when the triangular patches around a vertex are distributed on the same plane, that is, when n=1, the vertex transformation rule can be regarded as a translation distance d along the direction of the normal vector of the plane, that is, the coordinate transformation formula of the vertex is:
$$M = {M}_{0} + \vec{{n}_{1}} \cdot d$$
when the triangular patches around a vertex are distributed on two planes, that is, when n=2, the vertex transformation rule can be regarded as a translation distance D along the combined vector direction of the two planes, that is, the coordinate transformation formula of the vertex is:
$$M = {M}_{0} + \vec{n} \cdot D = {M}_{0} + \vec{n} \cdot \frac{d}{cos 〈 \vec{n} , \vec{{n}_{1}} 〉}$$
when the triangular patches around a vertex are distributed in three or more planes, that is, when n≥3, solving and obtaining the vertex coordinates after transformation at this time can be transformed into a problem of finding intersection points on multiple planes, that is, the coordinate transformation formula of the vertex is:
arg min∥Am−b∥
wherein A is the plane equation coefficient matrix, m is the transformed point coordinates, and b is a constant term, and their expressions are as follows:
$$A = ( \begin{matrix}{A}_{1} & {B}_{1} & {C}_{1} \\ ⋮ & ⋱ & ⋮ \\ {A}_{n} & {B}_{n} & {C}_{n}\end{matrix} ) ;$$
$$m = {( x , y , z )}^{T} ;$$
$$b = ( \begin{matrix}{A}_{1} ( {x}_{0} + {dA}_{1} ) + {B}_{1} ( {y}_{0} + {dB}_{1} ) + {C}_{1} ( {z}_{0} + {dC}_{1} ) \\ ⋮ \\ {A}_{n} ( {x}_{0} + {dA}_{n} ) + {B}_{n} ( {y}_{0} + {dB}_{n} ) + {C}_{n} ( {z}_{0} + {dC}_{n} )\end{matrix} ) ;$$
the model adaptive compensation can be achieved by correcting the normal vector direction \vec{n_{ι}}=(Aᵢ, Bᵢ, Cᵢ), i=1 . . . n in the above coordinate transformation rules and distance d according to the adaptive rules on the translation direction and distance of each patch.

6. A method according to claim 2, characterized in that: the model adaptive compensation, after the adaptive rules are changed, can also be used in other forms of additive and subtractive composite manufacturing to achieve a reservation of precision finishing allowance in the additive and subtractive composite manufacturing process from a model level.

7. A method according to claim 2, characterized in that, the self-supporting design is: first, determine a maximum build angle of the powder bed of the additive manufacturing machine; then search for a plan in the design model of which an angle between a tangent direction and a construction direction is greater than a maximum construction angle, that is, a large-angle overhang surface; finally, an angle of the large-angle overhanging surface is compensated to the maximum construction angle of the machine, so that it can be free-of-support during the printing process and an optimized model is obtained.

8. A method according to claim 7, characterized in that, a self-supporting structure being added in the self-supporting design is capable of being removed in subsequent subtractive processing.

9. A method according to claim 1, characterized in that, step (b) further comprises three stages, which are model decomposition, internal surface tool path planning and model reconstruction;
the model decomposition stage is: based on the internal structural characteristics of the additive model under conditions of determined placement angle, machining accuracy and tool parameters of the additive model, use a plurality of cutting planes perpendicular to the construction direction to decompose the additive model into a plurality of sub-models that the internal surface machining tool path is being planned at one time, and output a sub-model construction sequence;
in the internal surface tool path planning stage, CNC machining only processes the internal surface of the part, when planning the machining tool path, processing each sub-model after the additive model is decomposed is used as a blank and the design model as the target part respectively, if the model has a large-angle overhanging internal cavity structure, a free-of-support strategy is needed to achieve the support-free integrated manufacturing of the internal large-angle overhanging structure: the internal surface tool path planning stage will generate machining tool path files with the same number as the number of sub-models;
the model reconstruction stage is based on the machining accuracy requirements, alternately process additive manufacturing and CNC machining by using the sub-models obtained in the model decomposition stage and the machining tool path files obtained in the in the internal surface tool path planning stage according to the construction sequence until composite manufacturing of all sub-models is completed.

10. A method according to claim 9, characterized in that, the free-of-support strategy is: when building a sub-model having a large-angle overhanging internal cavity structure, set a first layer cutting area to a lower 9/10 part of a first layer self-supporting structure and keep an upper 1/10 part; set an n-th (n>1) layer cutting area to a lower 9/10 part of an n-th layer self-supporting structure and an upper 1/10 part of an n−1 layer; set a last layer of cutting area as a last layer of the self-supporting structure part and 1/10 part of a penultimate layer; generate subtractive machining tool paths for each layer for subtractive processing according to parameters of the cutting tool being selected and setting of cutting area.

11. A method according to claim 10, characterized in that, the cutting tool being selected is a T-shaped milling cutter arranged for processing a negative-angle self-supporting structure; according to different forms of processing surfaces, the T-type milling cutters with different specifications and parameters are selected.

12. A method according to claim 1, characterized in that, the reprocessing of step (c) refers to: during the composite manufacturing process of the additive model during the decomposition and reconstruction stage, due to CNC machining being limited by the process characteristics of PBF, a part of the internal surface of the part cannot be precision finished; after removing the influence of powder and support, the five-axis machine tool is used to process precision finishing for the unmachined internal surface of the part again.

13. A method according to claim 1, characterized in that, the method utilizes a machine which comprises: an atmosphere protection shell (1), a five-axis rotary head (2) arranged inside the atmosphere protection shell (1), a cutting tool (9) connected to a bottom portion of the five-axis rotary head (2), a linear motor (10) connected to the five-axis rotary head (2), a laser galvanometer (3) connected to the linear motor (10), a powder spreading scraper (4) provided at a bottom portion of the atmosphere protection shell (1), a forming base plate (7) is provided at a lower middle part of the atmosphere protection shell (1) and comprises a powder bin (5) and a top powder mechanism (6) at one side and a powder collecting bin (8) at another side, the atmosphere protection shell (1) serves to form a low-oxygen environment to prevent the powder from over-burning.
